(19) United States
(12) Patent Application Publication
(10) Pub. No.: US 2025/0180303 A1
(43) Pub. Date: Jun. 5, 2025

(54) HEAT PUMP HAVING TWO THERMAL-ENERGY STORAGE AND RELEASE SYSTEMS

(71) Applicant: PROPELLANE, PARIS (FR)

(72) Inventor: Christophe PONCELET, JENA (DE)

(73) Assignee: PROPELLANE, PARIS (FR)

(21) Appl. No.: 18/844,025

(22) PCT Filed: Mar. 10, 2023
(86) PCT No.: PCT/EP2023/056238

§ 371 Date: Sep. 4, 2024

(30) Foreign Application Priority Data
Mar. 11, 2022 (FR) FR2202181
Mar. 3, 2023 (FR) FR2302010

(51) Int. Cl. F28D 20/00; F25B 30/02

(52) U.S. Cl. CPC F28D 20/0034; F25B 30/02

(57) ABSTRACT

The invention relates to a heat pump, wherein: at least one of the at least two thermal-energy storage systems is configured to store thermal energy in the form of heat at a temperature between +100° C. and +800° C., at least one of the at least two thermal-energy storage systems is configured to store thermal energy in the form of cold at a temperature between −100° C. and +150° C.; and at least one thermal-energy release system is configured to release heat and/or cold separately or in parallel over time, or at least one thermal-energy release system is configured to operate in a parallel release mode that may be alternated with an operation mode of separate release of heat and/or cold over time.

The invention relates to an electric heat pump, comprising at least two thermal-energy storage systems allowing for thermal-energy releases between −100° C. and +800° C., in particular thermal-energy releases in the form of heat at a temperature between +100° C. and +800° C. and/or cold at a temperature between −100° C. and +150° C., as well as a method of supplying such thermal-energy using such a heat pump. In the context of the present invention, “cold” is to be understood as “relative” cold, by comparison with the temperatures involved in the production of thermal energy in the form of heat.

In its 2019 report (Decarbonizing the Electricity sector & Beyond; a report from the 2019 ASPEN Winter Energy Roundtable), the “ASPEN Winter Energy Roundtable” identified five key elements involved in achieving in-depth decarbonization of the energy system:
1. Maximizing energy efficiency to reduce energy requirements;
2. Decarbonizing electricity supply;
3. Economy-wide electrification to drive clean electricity into other sectors;
4. Utilizing carbon-free fuels for the remaining areas that cannot be efficiently electrified; and
5. Utilizing carbon capture, utilization and storage (“CCUS”) and carbon dioxide removal (“CDR”) for areas where fossil fuels are still needed and to achieve negative emissions.

There has been a great deal of effort, investment and innovation in these areas.

Efforts to improve energy efficiency in industry include:
Improvement and investment in energy-efficient technologies such as heat pumps and cooling units; and
Recovery of so-called “waste” energy: once again using heat pumps, ORC systems (Organic Rankine Cycle) or simple storage (i.e. release with an efficiency of less than 1) of thermal-energy.

Waste energy is the residual energy (i.e. lost if not recovered) produced by buildings and industries.

Efforts to decarbonize the power grid and to meet the need for flexibility, particularly in terms of storage, are in particular:
Massive investment in renewable energies (wind, solar, tidal and hydrokinetic). However, the intermittency of most of these means of production leads to an increased need for flexibility, i.e. simultaneous adaptation of electricity demand and production, for example:
via electricity storage or the activation of electricity-consuming systems in the event of excess on the grid; and
via systems for shedding electrical loads (machines) or using electricity storage in the case of a deficit.

This is the sector where it seems to have the most investment. Historically dominated by pumped-storage systems (also known as pumped hydro storage or PHS), and in recent years by large-scale Li-ion battery systems, the electricity storage sector has seen the emergence of many new technologies.

When it comes to electrifying high-temperature industrial processes, the needs and production of high-temperature heat and cooling are rarely optimized at the design stage. As the manufacturing of high and very high-temperature heat production equipment (boilers, burners, furnaces, vapor, etc.) is one specialty in itself, and the manufacturing of low and very low-temperature cold production equipment (cooling units, refrigeration, cryogenics, etc.) is another specialty, the industries are separate. This follows a historical and technological logic, which explains the separation of the two sectors and their specific characteristics.

However, the end-use industries have long since integrated reliability (i.e. constant availability) and low cost of industrial heat, notably gas and/or fuel oil, into their practices and business models for their needs above 100° C. With a cost in 2019 of around €50-55 per MWh of thermal energy from natural gas in France (ADEME, Brochure ref. 010895, January 2020, €51-85 per MWh), as well as in many other European countries (for large sites), it is very difficult for manufacturers to electrify their heat production facilities—as this would entail an additional heat cost of around 50% or more—or to replace them with production facilities based on renewable energies (again: additional costs, technical limitations and intermittency issues).

In addition, it is interesting to note that many sectors have industrial processes requiring:
high-temperature heat (>100-120° C. and up to 400° C.); and
cold/refrigeration (down to −50° C.).

For example, these needs are particularly found in the following industries:
agri-foodstuffs (especially ready-made meals, dried foods, powders (milk, coffee, etc.);
pharmaceutical (powders, pills . . . );
chemicals in the broad sense (preparation, packaging and storage of products), such as petrochemicals (gas and oil, plastics, rubber, etc.), adhesives, etc.; and
certain supermarkets and large catering outlets (especially fast-food outlets).

In this context, certain heat pump systems for simultaneous heating and cooling are known from the prior art.

For example, DE102018221850A1 discloses a heat pump system allowing for heating and cooling (between −15° C. and 60° C.), with a liquid-liquid heat pump connected on one side to a heat source and on the other side to a heat sink, particularly featuring a hot water tank.

JP2016211830A discloses the use of a heat pump for heating and cooling. More specifically, the temperature ranges disclosed are between 0° C. and approximately 100° C.

JP3037649B2 discloses a dehumidifying air-conditioning system, in which the energy efficiency of the air-conditioning system as a whole is increased to reduce operating costs, while minimizing energy consumption during the day and minimizing heat radiation to the outside air during night-time heat buildup.

However, none of these systems can simultaneously or alternatively deliver high and/or very high temperature heat and low and/or very low temperature cold.

In the specific context of the manufacturing and electricity supply industry, there are other systems for storing heat and cold, possibly simultaneously. Patents EP2220343, EP2574740, U.S. Pat. No. 10,907,510, U.S. Pat. No. 8,627,665, US20140223910 can illustrate this type of technology. However, the devices described in these documents are specific to the electricity manufacturing and supply industry, as they are designed specifically for electricity storage and are therefore dimensioned to operate in cycles “which must be temperature-rebalanced” after charging and discharging. Such devices cannot therefore be used as such in other industries (in particular those mentioned above) or even privately.

### SUMMARY OF THE INVENTION

The aim of the present invention is therefore to overcome the drawbacks of the prior art by offering an electric heat pump, comprising:
at least two thermal-energy storage systems, and
at least one thermal-energy release system,
   wherein:
at least one of the thermal-energy storage systems is configured to store thermal energy in the form of heat at a temperature of between +100° C. and +800° C.,
at least one of the thermal-energy storage systems is configured to store thermal-energy in the form of cold at a temperature between −100° C. and +150° C.; and
said at least one thermal-energy release system is configured to release heat and/or cold separately or in parallel, or
said at least one thermal-energy release system is configured for operation in a parallel release mode that can be alternated with operation in time-separated release mode of heat and/or cold; the heat pump being configured to comprise a reversed Brayton cycle (e.g. without phase change) operating with a gas, and comprising a single-stage centrifugal electric turbocharger.

Simultaneous production of the two streams (high-temperature heat and cold, usually negative) makes it possible to achieve better energy performance and provide manufacturers with a thermal-energy supply solution that drastically reduces CO₂ emissions without increasing production costs, or even reducing them depending on the prices of locally available energy sources. Furthermore, the use of a single-stage centrifugal electric turbocharger increases the compactness and efficiency of the heat pump, as well as reducing its cost. In addition, such a single-stage centrifugal electric turbocharger operates without oil, preventing any contamination or acidification within the system. The use of a single turbocharger means that there is only one operating point (usually defined by the flow rate/compression ratio) for the compressor/turbine pair in the gas circulation circuit, common for a charge and discharge cycle of the heat pump.

The term “single turbocharger”, also known as “single turbomachine”, is used in the context of the present invention to mean a single machine capable of both simultaneously increasing gas pressure and reducing gas pressure at another point in the circuit. In addition to high-output axial-type turbochargers, there are at least two types of radial-type turbochargers: piston-type turbochargers (usually referred to as “compressors”) and centrifugal turbochargers. Centrifugal turbochargers have few frictional moving parts, relatively high energy efficiency and higher gas flow than similarly sized reciprocating compressors. Turbochargers cannot achieve as high a compression ratio as reciprocating compressors, the latter being capable of reaching a pressure of 100 MPa in multi-stages.

In the context of the present invention, the term “single-stage turbocharger” refers to a turbocharger comprising a single compression and expansion train, i.e. a single compression structure (or part), also known as a “compressor”; and a single expansion structure (or part), also known as a “turbine”.

Preferably, the single-stage centrifugal electric turbocharger has a compression ratio of between 1 and 5, the compression ratio being defined as the ratio between the outlet pressure of the compressor part of the turbocharger and the inlet pressure of said compressor part. The choice of this particular range of values for the compression ratio provides a single operating point for the compressor/turbine pair, particularly suitable for enabling both charge and discharge cycles of the heat pump, with adapted pressure and temperature levels and flow rates. In this particular value range, the heat pump also maintains high energy efficiency and a significant flow of displaced gas.

Preferably, the heat pump according to the present invention can be characterized in that:
at least one of the thermal-energy storage systems is configured to store thermal-energy at temperatures between −50° C. and +100° C., and/or
in which at least one of the thermal-energy storage systems is configured to store thermal-energy at temperatures between +150° C. and +500° C., preferably between +200° C. and +400° C.

Preferably, the heat pump according to the present invention can be characterized in that said at least two thermal-energy storage systems are configured to store thermal-energy in the form of heat and in the form of cold.

Preferably, the gas used in the heat pump's reversed Brayton cycle can be air (i.e. about 20% oxygen in about 80% nitrogen), or a noble gas such as helium or argon, or a mixture of these gases.

The gas can alternatively be an inert gas such as nitrogen.

Preferably, the single-stage centrifugal electric turbocharger generates a pressure of less than or equal to 8 bar, preferably between 1 and 5 bar (corresponding to said compression ratio of between 1 and 5, for a gas initially at atmospheric pressure).

Preferably, the heat pump according to the present invention can be characterized in that the various operating elements of said heat pump are isolated in modules, said modules being configured to be connected to each other for example by physical connections such as valves (e.g. remotely controllable), pipes to be connected and/or hoses.

Preferably, the heat pump according to the present invention can be characterized in that it is configured to be coupled to at least one natural heat source and/or at least one artificial heat source such as a gas boiler, a gas furnace, heat of solar origin, a dryer and/or heat loss of artificial origin.

Preferably, the heat pump according to the present invention can be characterized in that it is configured to be coupled to at least one artificial heat source, in particular the exhaust, loss or outlet of an artificial heat source such as the exhaust, loss or outlet of a gas boiler, a gas furnace, solar heat or waste heat, a dryer and/or heat loss of artificial origin.

“Exhaust” is understood in the context of the present invention to mean a final controlled phase of energy circulation, for example in the form of hot vapor or smoke, from an artificial heat source.

In the context of the present invention, “loss” means a useful deprivation of energy from the artificial heat source. This deprivation is most often uncontrolled, difficult to control or the result of poor management or configuration of the artificial heat source.

In the context of the present invention, the term “output” of a heat source is understood to mean a channeled and expected output from a heat source, i.e. where the majority of said heat is expected to be recovered (from steam condensates, for example, via the return circuit of a process).

In a particular embodiment, the heat pump according to the present invention can be characterized in that it is configured to be connected to a heating circuit and/or a cooling circuit. Preferably, the heat pump according to the present invention can be characterized in that it is configured to be connected to a primary heating circuit and/or a primary cooling circuit.

Preferably, the heat pump according to the present invention can be characterized in that it is dimensioned to supply an energy of between 50 kWh and 5 MWh.

In a particular embodiment, the heat pump comprises four thermal-energy storage systems, two thermal-energy release systems, two three-way valves and two pumping members; a first end of a first thermal-energy storage system being connected to a first end of a second thermal-energy storage system via a first gas flow branch; a first end of a third thermal-energy storage system being connected to a first end of a fourth thermal-energy storage system via a second gas flow branch; a first thermal-energy release system being arranged to exchange thermal-energy with the first gas flow branch, a second thermal-energy release system being arranged to exchange thermal-energy with the second gas flow branch; a first three-way valve being connected to a second end of the first thermal-energy storage system, to a second end of the second thermal-energy storage system and to a second end of the third thermal-energy storage system; a second three-way valve being connected to the second end of the second thermal-energy storage system, to the second end of the third thermal-energy storage system and to a second end of the fourth thermal-energy storage system; a first pumping member connecting the second end of the second thermal-energy storage system to the corresponding channel of the first three-way valve; a second pumping member connecting the second end of the third thermal-energy storage system to the corresponding channel of the second three-way valve; the inlet of the compressor part of the electric turbocharger being connected to the first end of the first thermal-energy storage system at a first connection point on the first gas flow branch; the outlet of the compressor part of the electric turbocharger being connected to the first end of the second thermal-energy storage system at a second connection point on the first gas flow branch; the inlet of the turbine part of the electric turbocharger being connected to the first end of the fourth thermal-energy storage system at a first connection point on the second gas flow branch; the outlet of the turbine part of the electric turbocharger being connected to the first end of the third thermal-energy storage system at a second connection point on the second gas flow branch.

This particular embodiment allows for a specific sequence of gas flow through the various thermal-energy storage systems (and therefore the temperatures involved), which are not the same depending on whether the heat pump is in a charge or discharge cycle (by virtue of the use of valves and pumping components). Such a configuration thus allows the gas to be compressed from potentially higher temperatures, and thus either to produce higher temperatures, or to produce the same temperature but with a lower compression ratio. The heat pump in this particular embodiment can also produce heat and/or cold at a different time of use, and can store both types of thermal energy. By virtue of separate release circuits, the heat pump can also provide heat and/or cooling simultaneously or independently.

According to a preferred variant of this particular embodiment, the heat pump further comprises a two-way valve and three non-return valves; the two-way valve being connected on the first gas flow branch between the first connection point and the second connection point; a first non-return valve being connected between the outlet of the compressor part of the electric turbocharger and the second connection point of the first gas flow branch; a second non-return valve being connected between the outlet of the turbine part of the electric turbocharger and the second connection point of the second gas flow branch; a third non-return valve being connected on the second gas flow branch; a second non-return valve being connected between the output of the turbine part of the electric turbocharger and the second connection point of the second gas flow branch; a third non-return valve being connected on the second gas flow branch between the first connection point and the second connection point.

In another particular embodiment, which is a refinement of the embodiment previously described, the heat pump further comprises three additional thermal-energy release systems, four additional two-way valves and four additional three-way valves; a first end of a first additional thermal-energy release system being connected to a first end of the first thermal-energy release system via a first two-way valve; a second end of the first additional thermal-energy release system being connected to a second end of the first thermal-energy release system via a second two-way valve; a first end of a second additional thermal-energy release system being connected to a first end of the second thermal-energy release system via a third two-way valve; a second end of the second additional thermal-energy release system being connected to a second end of the second thermal-energy release system via a fourth two-way valve; a first end of a third additional thermal-energy release system being connected to the first connection point on the first gas flow branch; a second end of the third additional thermal-energy release system being connected to the second connection point on the second gas flow branch; a first additional three-way valve is connected to the inlet of the compressor section of the electric turbocharger, to the first connection point on the first gas flow branch and to the first end of the third additional thermal-energy release system; an additional second three-way valve being connected to the outlet of the compressor part of the electric turbocharger, to the second connection point on the first gas flow branch and to one of the channels of an additional third three-way valve via a first gas line; the additional third three-way valve being further connected to the inlet of the turbine part of the electric turbocharger and to the first connection point on the second gas flow branch; a fourth additional three-way valve being connected to the outlet of the turbine part of the electric turbocharger, to the second connection point on the second gas flow branch and to the second end of the third additional thermal-energy release system via a second gas line; the first and third additional thermal-energy release systems each being arranged to exchange thermal-energy with the first gas line; the second additional thermal-energy release system being arranged to exchange thermal-energy with the second gas line.

In addition to the advantages associated with the previous design (and outlined above), this particular heat pump design is able to produce heat and cold instantaneously, at the same time as discharging heat and cold from thermal-energy storage systems. This is advantageous because it allows instantaneous power to be added to the heat pump's discharge cycle, for example to address peak demand with minimal additional equipment costs (three additional thermal-energy release systems). This avoids the need to oversize the system (e.g. by increasing the size of thermal-energy storage systems to store more and/or by increasing the size of the machine, e.g. to produce and store more at night).

A further object of the present invention relates to a process for supplying thermal-energy in the form of heat at a temperature between +100° C. and +800° C. and/or cold at a temperature between −100° C. and +150° C., using a heat pump as described above, comprising the following steps:
(a) a charge cycle step by mechanical compression of at least one gas with preferential mechanical expansion of said at least one gas;
(b) a discharge cycle step without compression and/or expansion in which the thermal-energy is discharged via at least one thermal-energy release system, for example via at least one valve, at least one circulator (typically a pump) and/or at least one heat exchanger (i.e. a heat exchanger).

In a particular embodiment, step (a) is a charge cycle by mechanical compression of at least one vapor, preferably with a mechanical expansion of said at least one vapor.

Preferably, the method according to the present invention can be characterized in that step (b) of the discharge cycle takes place in parallel with step (a) of the charge cycle.

The discharge cycle induces a flow of fluid (such as a heat transfer gas) called “discharge flow”. Thus, in one particular embodiment, the discharge flow can be divided into several discharge flows, called divided discharge flows, each of which can be directed towards different applications.

For example, a split discharge stream can be directed to a storage system, such as a secondary storage system, which can allow for temperature stratification.

### Definitions

In the context of the present invention, the term “heat pump” refers to a device for transferring thermal energy from a first medium to a second, higher-temperature medium, thus going against the natural spontaneous direction of thermal energy. In particular, there are so-called high-temperature, very-high-temperature, low-temperature and very-low-temperature heat pumps. There are traditionally different types of heat pump: vapor-compression heat pumps, Peltier-effect heat pumps, thermo-acoustic heat pumps, thermomagnetic heat pumps, gas-absorption heat pumps and Stirling heat pumps. Preferably, a “heat pump” in the context of the present invention is an electric heat pump of the air-cycle type (e.g. with a gas refrigeration cycle). This method follows a reversed Brayton thermodynamic cycle in which a gas is compressed, cooled to ambient temperature, then expanded in a turbine, and does not involve any phase change, which distinguishes it from vapor-compression heat pumps (“conventional” heat pumps, known as “thermodynamic” heat pumps) most often following a vapor-compression refrigeration cycle, or a gas-absorption heat pump.

This heat pump works by recovering calories from a low-pressure storage tank known as the “cold” tank. The gas is then compressed in a compressor to raise its temperature. In the context of the present invention, this heat is stored. At the same time, the cold generated at the turbine outlet (expansion) is also recovered and stored.

A Brayton cycle driven in reverse is called a reversed Brayton cycle. Its purpose is to move heat from a colder body to a warmer one, rather than to produce work. In accordance with the second principle of thermodynamics, heat cannot flow spontaneously from the cold system to the hot system without external work being done on the system. Heat can flow from a colder body to a warmer one, but only when forced by external work. That is exactly what refrigerators and heat pumps accomplish. These are driven by electric motors that need to work from their environment to operate. Thus, one possible cycle is a reversed Brayton cycle, which is similar to the regular Brayton cycle but is driven in the opposite direction, via a net work input. This cycle is also known as the gas refrigeration cycle, the air cycle or the Bell Coleman cycle. This type of cycle is widely used in commercial airplanes or trains for air-conditioning systems using air from engine compressors. It is also widely used in the LNG (Liquefied Natural Gas) industry where the largest Brayton inverted cycle is for LNG subcooling using 86 MW of power from a gas turbine-driven compressor and nitrogen refrigerant (source of this common knowledge: thermal-engineering.org).

“High temperature” is understood in the context of the present invention to mean a temperature range between +60 and +100° C., preferably between +70 and +95° C. This type of heat pump can be found in commercial heat pumps, including so-called “consumer” heat pumps. Their efficiency decreases as the temperature differential between the cold source and the heat source increases.

The temperatures given in the context of the present invention, unless otherwise indicated, are in reference to the temperature of 0° C., i.e. the solidification temperature of water at one atmosphere at sea level (i.e. 101325 Pa corresponding to an absolute pressure of 1 bar).

By “very high temperature”, it is understood in the context of the present invention to mean a temperature range greater than +100° C., for example greater than or equal to +150° C., greater than or equal to +200° C., greater than or equal to +300° C., greater than or equal to +400° C. Thus, a very high temperature in the context of the present invention may comprise temperatures between +150 and +500° C., preferably between +150 and +400° C., or even between +250 and +350° C.

By “low temperature”, it is understood in the context of the present invention to mean a temperature range between −20 and +5° C., preferably between −15 and −5° C.

By “very low temperature”, it is understood in the context of the present invention to mean a temperature range lower than −20° C., for example lower than or equal to −30° C., lower than or equal to −40° C., lower than or equal to −50° C., lower than or equal to +60° C. Thus, a very low temperature in the context of the present invention may comprise temperatures between −30 and −150° C., preferably between −40 and −100° C., or even between −50 and −80° C.

In the context of the present invention, “thermal-energy storage systems” means any means of preserving a quantity of energy of a thermal nature for later use. Thermal nature can be hot or cold. Indeed, heat as such is a form of energy. In the case of stored cold, since cold production requires energy, storing cold represents energy storage.

In the context of the present invention, the term “thermal-energy delivery system” means a means of delivering thermal energy. Furthermore, the expression “thermal-energy release systems configured for” implies that the tanks are interchangeable (one can be used for heating and then for cooling in other series of charge/discharge cycles).

In the context of the present invention, the term “separate or parallel release of thermal energy” means the separate or parallel release of thermal energy from at least two different storage systems. Separate delivery thus enables thermal energy from at least one first storage system to be supplied first, followed by thermal energy from at least one second storage system. Parallel delivery enables thermal energy from at least one first storage system and thermal energy from at least one second storage system to be supplied at the same time.

In the context of the present invention, “module” means an element that can be juxtaposed or even combined with one or more others, which may be of the same nature as or complementary to the first.

In the context of the present invention, the term “natural heat source” is taken to mean thermal energy derived from no human intervention, such as a geothermal or water source (lake, sea, river, etc.) for example.

In the context of the present invention, “artificial heat source” is understood to mean thermal energy generated by human intervention, such as a furnace, boiler, equipment such as air conditioning, compressors, machines, generators, a residential, commercial, tertiary, industrial and/or computer process, energy from a solar thermal system, or even waste heat.

In the context of the present invention, “charge cycle” is understood to mean a series of events, which may be recurrent, i.e. a cycle, enabling the production of thermal energy which is either distributed instantaneously or stored in the form of thermal energy.

In the context of the present invention, “gas” means any body in a gaseous state. Thus, a gas also includes a vapor, which results from the vaporization of a liquid (at any temperature).

In the context of the present invention, the term “mechanical expansion” refers to the expansion of initially compressed gas via a turbine.

In the context of the present invention, the term “discharge cycle” is understood to mean the reverse function of a charge cycle, i.e. the release of thermal energy stored in storage systems.

In the context of the present invention, “heat exchanger” means a device for transferring thermal energy from one fluid to another without mixing them. It is therefore a question of a “carrier fluid”, i.e. a fluid as defined above, allowing the thermal energy to be moved from one location to another.

By way of example, there are liquid/liquid, gas/liquid or gas/gas heat exchangers such as plate heat exchangers or tube or shell-and-tube heat exchangers that can be used within the scope of the present invention. There are many suppliers of such heat exchangers, such as Alfa-Laval®.

### DETAILED DESCRIPTION

The object of the present invention makes it possible to adapt, improve and at the same time combine:
a proven technology for increasing efficiency and adapting it to the needs of thermal processes (heat and refrigeration),
special electric turbomachines (electric turbochargers), the speed of which can be controlled (via the regulation of the flow rate/speed of rotation and compression ratio) using power electronics and software, for example,
thermal storage (separate cooling and heating) to add flexibility to the system and enhance the appeal of the solution for industrial users.

Thus, the object of the present invention may comprise one or more sensors, which, combined with the use of software (and its algorithms), allow for the heat pump to be controlled according to the present invention.

In addition, the object of the present invention provides several key innovative elements in terms of technology and functionality:
electrical production of high-temperature heat (>150° C. and up to 500-800° C.) and industrial cooling (down to −50° C.) with a COP (coefficient of performance-efficiency) of 1.5 or more,
use of a refrigerant (such as air or argon) with a GWP (global warming potential) of 0;
high-density energy storage in thermal form of this generated or heated/supercooled energy: heat (>150° C.) and industrial cold (down to −50° C.) in the same module, capable of storing energy for several hours or even a few days.

The various components (electric turbo-compressor, motor, storage system, etc.) of the heat pump according to the present invention can be placed in one or more modules or sub-modules that can be combined or integrated with one another; the whole assembly can be contained in a container (for example, standard “20-foot” or “40-foot” containers, i.e. approximately 6 meters or 12 meters) or placed on a chassis.

Modules or sub-modules as defined above can be combined with other similar modules or sub-modules as required.

All these modules and/or sub-modules can be used to integrate and upgrade waste energy or solar thermal-energy flows, for example by adding one or more heat exchangers. Thus, the object of the present invention further provides a method for elevating the temperature of recovered waste or solar heat, storing it, and subsequently releasing it as needed.

Thus, in a particular embodiment, the various functional elements of the heat pump according to the present invention can be isolated in modules. Thus, a modular system allows the heat pump to be easily adapted to the physical layout of the site where it is to be installed. Indeed, modularity means that the heat pump can be adapted according to on-site production, for example by increasing or decreasing thermal-energy production (power) or storage (energy) capacities. Furthermore, modularity allows for original assembly variations. For example, modularity can allow for several storage systems to be inserted to provide a diversity of temperatures, whether at the input (recovery of waste energy with different temperature levels and/or temperature variations) and/or at the output (production of thermal energy at a certain temperature and/or with variable temperature requirements).

In addition, it can be advantageous to install rail and/or chassis systems (“skids”) to facilitate modularity.

In a particular embodiment, the modules comprising the various elements are adapted for movement in containers.

The recombination of modules allows for limiting the number of module variants and thus optimizing the cost of systems while being able to address a greater number of different needs.

In addition, thermal-energy storage according to the present invention can be achieved by installing in storage systems such as tanks (e.g. those mentioned above), elements enabling thermal energy to be absorbed and stored during a charging phase, for example by stacking blocks of reduced size (in comparison with said tanks) on different levels. These blocks can take the form of gravel, refractory bricks, ceramic parts, cement parts, rock parts (e.g. volcanic or granitic), or zeolites.

Alternatively, the stacking on different levels can take the form of capsules containing conventional PCMs (phase change materials) such as certain sands (such as molten salts), notably KNO₃-60% NaNO₃ or NaCl/MgCl₂ (57/43) used for over 20 years in concentrated solar power plants (CSP), of kerosene or CaCl₂6H₂O.

All these materials and elements have been abundantly used for many years in various fields and systems and are also very well documented in numerous journals, publications, just to give an example in the document “State-of-the-Art Review: “Insulation and Thermal Storage Materials”, 2013 (Eclipse, Cambridge Architectural Research Limited).

This same thermal energy (minus the thermal losses inherent in the system) will of course be released upon discharge.

This storage aspect is advantageous to the proper functioning of the invention.

The tanks and pipes will be thermally insulated with conventional insulating materials such as wool rock or other standard insulation.

The heat pump according to the present invention thus comprises at least two cycles, one called the charge cycle and the other called the discharge cycle.

For example, a charge cycle may include:
compression of the fluid (i.e. the gas) between 1-5 bar (starting from 1 bar with a compression ratio between 1 and 5) (and therefore, for example, heated to 150-300° C. in the case where the gas is air) in the compressor;
a discharge of heat from the fluid in the material/storage element into a first tank;
expansion in the turbine of the compressed air, which has been cooled during its passage through the first vessel, but is still under pressure;
Reheating in a second tank of very cold air (between −100 and +10) at greatly reduced pressure due to expansion by the turbine (and therefore “transmission of cold”)
the “heated” cold air returns to the compressor;
the cycle is restarted until the tanks are full (information provided by sensors and/or the shutdown of the system-controlled electric turbocharger).

For example, a discharge cycle may include:
circulators installed on the external loop of each tank (distribution), transferring the energy from the tanks to the heat exchangers installed on the client's process loops;
at the exchanger outlet, the distribution loop recovers the client process return;

Thus, no compression or expansion is used in this cycle, only circulators and/or pumps. Cold and hot energy distribution systems are independent, so discharge can occur at the same time or alternately. The discharge stops if the client's request is reached or if the tanks are empty (once again, the information provided by sensors is used by the circulator control system to stop the process)

### BRIEF DESCRIPTION OF THE FIGURES

By way of non-limiting examples, embodiments of the present invention are described hereinafter, with reference to the appended figures, in which:

FIG. 1 shows a perspective view of a heat pump according to the present invention on a chassis;

FIG. 2 is a conceptual diagram representing a charge cycle of a heat pump according to the present invention;

FIG. 3 is a conceptual diagram representing a discharge cycle of a heat pump according to the present invention:

FIG. 4 is a schematic conceptual representation of a heat pump according to the present invention, seen from above;

FIG. 5 is a conceptual schematic representation of a heat pump according to the present invention, seen from above, in which said heat pump is connected to a source of waste energy;

FIG. 6 is a conceptual schematic representation of a heat pump according to the present invention, seen from above, in which said heat pump is connected to two additional thermal-energy storage systems;

FIG. 7 shows a perspective view of a heat pump according to the present invention in a container;

FIG. 8 is a conceptual diagram representing a particular embodiment of a heat pump according to the present invention, in a heat pump charge cycle, the heat pump comprising four thermal-energy storage systems;

FIG. 9 is a simplified schematic representation of the thermal-energy storage systems shown in [FIG. 8];

FIG. 10 is a conceptual diagram of the heat pump in [FIG. 8], in a heat pump discharge cycle;

FIG. 11 is a simplified schematic representation of the thermal-energy storage systems of [FIG. 10]; and

FIG. 12 is a conceptual diagram representing another particular embodiment of a heat pump according to the present invention, in a heat pump charge cycle, the heat pump comprising four thermal-energy storage systems;

FIG. 13 is a simplified schematic representation of the thermal-energy storage systems of [FIG. 12];

FIG. 14 is a conceptual diagram of the heat pump of [FIG. 12], in a heat pump discharge cycle; and

FIG. 15 is a simplified schematic representation of the thermal-energy storage systems in [FIG. 14].

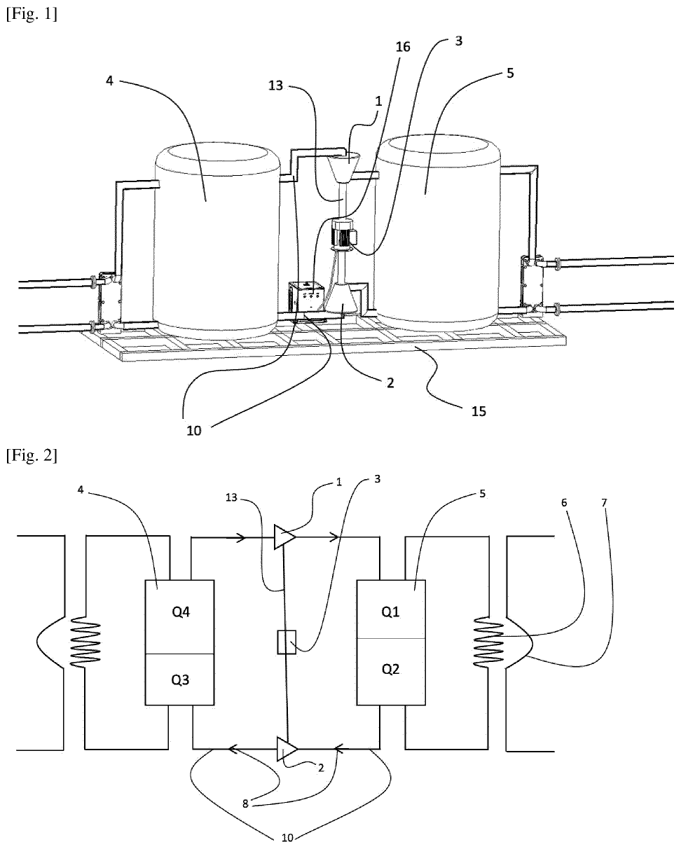

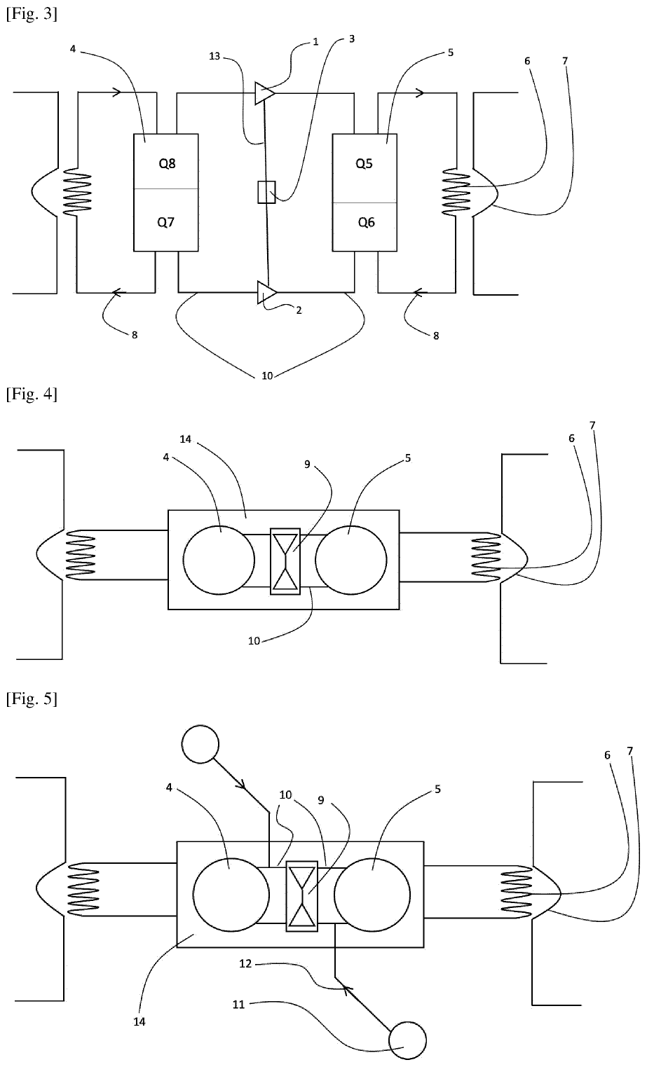

Referring to [FIG. 1], where a heat pump according to the present invention is shown in perspective on a chassis 15, a compressor 1 and a turbine 2 connected to each other by an electrical and/or mechanical link 13, driven by an electric motor 3, can be seen. Both the compressor and the turbine are connected by pipes 10 to a first storage system 4 on the one hand, and to a second storage system 5 on the other, thus establishing a loop between the compressor 1, the turbine 2, the first storage system 4 and the second storage system 5. The compressor 1 and turbine 2 form a single-stage centrifugal electric turbocharger.

[FIG. 2] is a schematic representation of the heat pump shown in [FIG. 1], connected to thermal-energy release systems 6, shown here in a charge cycle. The first storage system 4 and the second storage system 5 are each connected to a thermal-energy release system 6 for supplying heat or cold to a customer system 7. The direction of flow represented by the arrows 8 implies that thermal energy in the form of heat is concentrated in the second storage system 5, while thermal energy in the form of cold is concentrated in the first storage system 4. The storage of cold thermal energy is at low pressure. A temperature gradient can then be created in the first storage system 4 and in the second storage system 5 so that, theoretically, Q1 is at a higher temperature (i.e. hotter) than Q2, and Q3 is at a lower temperature (i.e. colder) than Q4. In [FIG. 2], no discharge is shown.

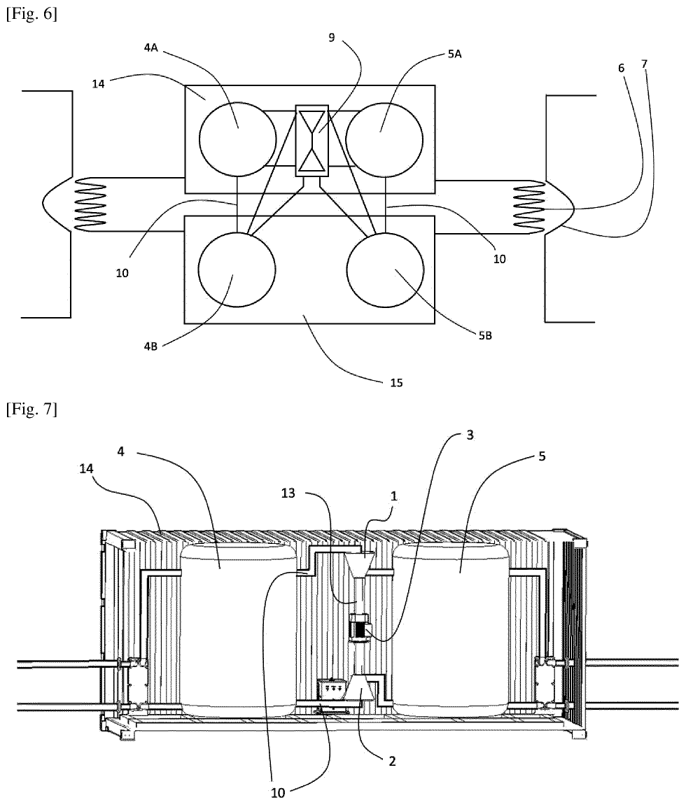

With reference to [FIG. 3], the assembly diagram identical to the one shown in [FIG. 2] is depicted here on a discharge cycle. By discharging the thermal energy stored in the first storage system 4 and the second storage system 5 to two thermal-energy release systems 6, it is possible to supply heat and cold to customer systems 7. In [FIG. 3], the second storage system 5 is cooled by this discharge, and so a temperature gradient can be created so that, theoretically, Q6 is at a lower temperature (i.e. colder) than Q5. Similarly, a temperature gradient can be created in the first storage system 4 so that, theoretically, Q8 is higher in temperature (i.e. hotter) than Q7. In FIGS. 2 and 3, it is clear that charge and discharge cycles can run in parallel.

[FIG. 4] is a top view of the assembly diagram shown in FIGS. 2 and 3. Compressor 1, turbine 2 and motor 3, together with its (electrical) power unit and any standard connections, are grouped together in a so-called working group 9. Working group 9, first storage system 4, second storage system 5 and pipes 10 constitute a first heat pump assembly 14 according to the present invention.

[FIG. 5] is a top-view representation of an assembly diagram based on the elements shown in [FIG. 4], with the addition of a source 11 of waste energy (or thermal energy of natural or solar origin) to supply thermal energy, represented by the arrow 12. Any means of capturing this waste energy can be applied (e.g. heat exchanger connected to the pipe circuit 10 of the heat pump assembly 14 according to the present invention. It is possible to place a thermal-energy input between the storage system 5 and the turbine of the work group 9, and/or between the storage system 4 and the (turbo) compressor of the work group 9.

[FIG. 6] shows a heat pump assembly 14 according to the present invention, comprising two thermal-energy storage systems 4A and 5A and a work group 9. An assembly 15 comprising two thermal-energy storage systems 4B and 5B, is connected to the heat pump assembly 14 according to the present invention. Workgroup 9 is doubly connected to each storage system 4A, 4B, 5A and 5B. In addition, the thermal-energy storage system 4A is connected to the thermal-energy storage system 4B by a pipe 10. The thermal-energy storage system 5A is connected by a pipe 10 to the thermal-energy storage system 5B.

In FIGS. 4, 5 and 6, the heat exchangers 6 are positioned outside the assemblies 14, 15. Alternatively, the heat exchangers may be located in assemblies 14, 15.

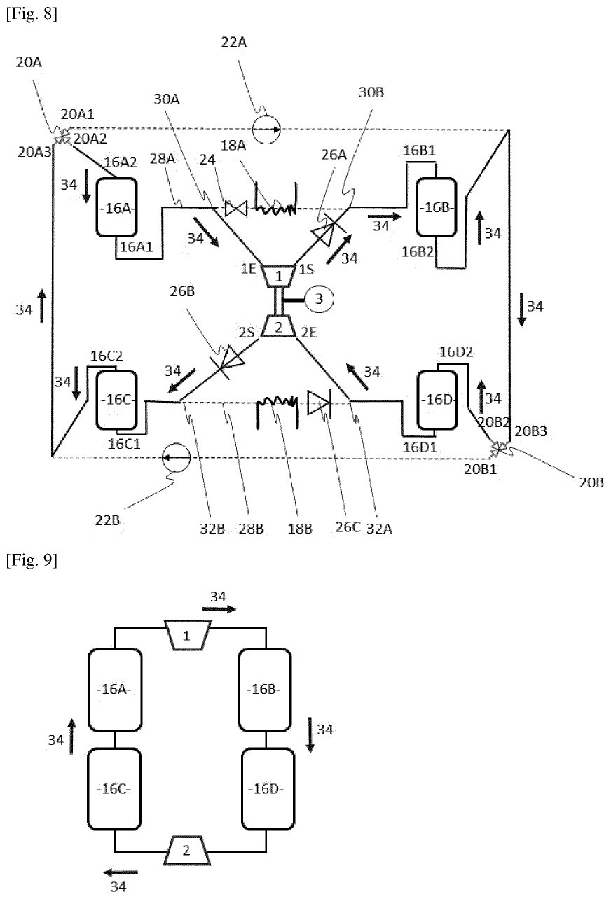

In practical terms, the assemblies 14, 15 of FIGS. 4, 5 and 6 can be containers.

[FIG. 7] is a perspective view of the heat pump shown in [FIG. 1] inserted in a container 14.

[FIG. 8] is a conceptual diagram representing a particular embodiment of

a heat pump according to the present invention, in a heat pump charge cycle. In this particular embodiment, in addition to the single-stage centrifugal electric turbocharger 1, 2, the heat pump features four thermal-energy storage systems 16A-16D, two thermal-energy release systems 18A, 18B, two three-way valves 20A, 20B, two pumping elements 22A, 22B, a two-way valve 24 and three non-return valves 26A-26C.

A first end 16A1 of a first thermal-energy storage system 16A is connected to a first end 16B1 of a second thermal-energy storage system 16B via a first gas flow branch 28A. A first end 16C1 of a third thermal-energy storage system 16C is connected to a first end 16D1 of a fourth thermal-energy storage system 16D via a second gas flow branch 28B.

A first thermal-energy release system 18A (preferably a heat exchanger) is arranged to exchange thermal energy with the first gas flow branch 28A. A second thermal-energy release system 18B (preferably a heat exchanger) is arranged to exchange thermal energy with the second gas flow branch 28B. A first three-way valve 20A is connected to a second end 16A2 of the first thermal-energy storage system 16A, to a second end 16B2 of the second thermal-energy storage system 16B and to a second end 16C2 of the third thermal-energy storage system 16C. A second three-way valve 20B is connected to the second end 16B2 of the second thermal-energy storage system 16B, to the second end 16C2 of the third thermal-energy storage system 16C and to a second end 16D2 of the fourth thermal-energy storage system 16D.

A first pumping member 22A (typically a pump) connects the second end 16B2 of the second thermal-energy storage system 16B to the corresponding channel 20A1 of the first three-way valve 20A. Another channel 20A2 of the first three-way valve 20A is connected to the second end 16A2 of the first thermal-energy storage system 16A, and the last channel 20A3 of the first three-way valve 20A is connected to the second end 16C2 of the third thermal-energy storage system 16C. A second pumping member 22B (typically a pump) connects the second end 16C2 of the third thermal-energy storage system 16C to the corresponding channel 20B1 of the second three-way valve 20B. Another channel 20B2 of the second three-way valve 20B is connected to the second end 16D2 of the fourth thermal-energy storage system 16D, and the last channel 20B3 of the second three-way valve 20B is connected to the second end 16B2 of the second thermal-energy storage system 16B.

The inlet 1E of the compressor part 1 of the electric turbocharger is connected to the first end 16A1 of the first thermal-energy storage system 16A at a first connection point 30A on the first gas flow branch 28A. The output 1S of the compressor part 1 of the electric turbocharger is connected to the first end 16B1 of the second thermal-energy storage system 16B at a second connection point 30B on the first gas flow branch 28A. The inlet 2E of the turbine part 2 of the electric turbocharger is connected to the first end 16D1 of the fourth thermal-energy storage system 16D at a first connection point 32A on the second gas flow branch 28B. The outlet 2S of the turbine part 2 of the electric turbocharger is connected to the first end 16C1 of the third thermal-energy storage system 16C at a second connection point 32B on the second gas flow branch 28B.

The two-way valve 24 is connected to the first gas flow branch 28A between the first connection point 30A and the second connection point 30B. A first non-return valve 26A is connected between the outlet 1S of the compressor part 1 of the electric turbocharger and the second connection point 30B of the first gas flow branch 28A. A second non-return valve 26B is connected between the outlet 2S of the turbine part 2 of the electric turbocharger and the second connection point 32B of the second gas flow branch 28B. A third non-return valve 26C is connected to the second gas flow branch 28B between the first connection point 32A and the second connection point 32B.

The operation of the heat pump in this particular embodiment is illustrated in FIGS. 8 and 9, when the pump is in a charge cycle. The direction of flow represented by the arrows 34 implies here that thermal energy in the form of heat is concentrated in the second storage system 16B (after having been extracted from the first storage system 16A and then compressed in the compressor 1), while thermal energy in the form of cold is concentrated in the third storage system 16C (after having been extracted from the fourth storage system 16D and then expanded in the turbine 2). Cold thermal-energy storage is at low pressure (typically around one bar absolute when the gas used is air), while hot thermal-energy storage is at high pressure (typically between one and five bar absolute when the gas used is air). Cold thermal-energy extraction is high pressure, while hot thermal-energy extraction is low-pressure. The temperature gradients created in the second and third storage systems 16B, 16C cause thermal energy to be transferred from the second storage system 16B to the fourth storage system 16D on the one hand, and from the third storage system 16C to the first storage system 16A on the other.

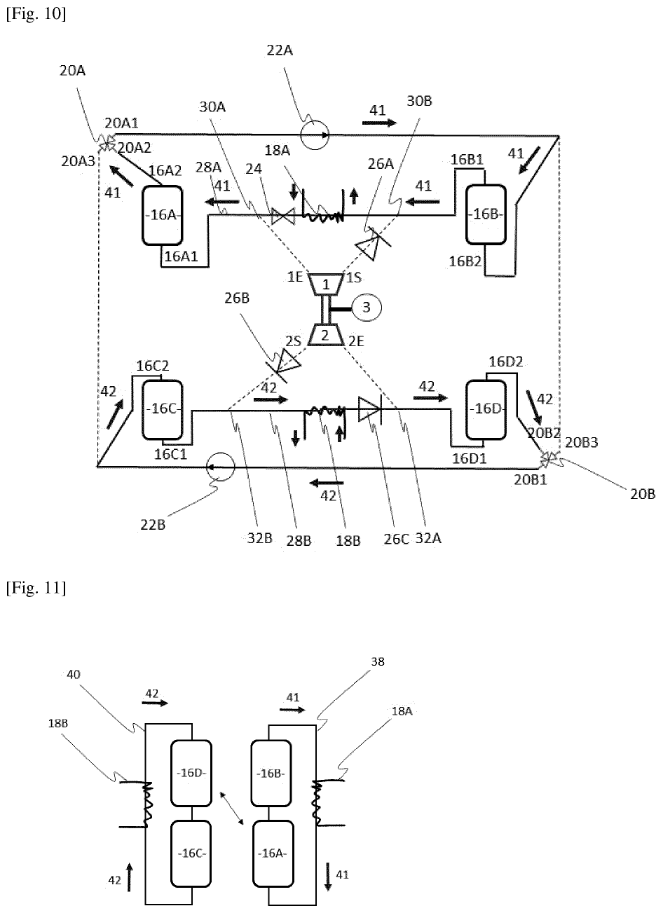

Operation of the heat pump in this particular embodiment is illustrated in FIGS. 10 and 11, when the pump is in a discharge cycle. By discharging the thermal energy stored in the second storage system 16B and in the third storage system 16C to the two thermal-energy release systems 18A, 18B, it is possible to supply heat and cold to client systems. A first loop 38 is thus established between the first storage system 16A and the second storage system 16B on the one hand, and a second loop 40 between the third storage system 16C and the fourth storage system 16D on the other. In the first loop 38 (in which the first pumping member 22A is started, and the heat pump supplies heat to the first thermal-energy release system 18A), the second storage system 16B cools down through discharge, creating a temperature gradient that causes the gas to circulate in the direction of flow represented by the arrows 41. In the second loop 40 (in which the second pumping member 22B is started, and the heat pump supplies cold to the second thermal-energy release system 18B), the third storage system 16C is heated by the discharge and a temperature gradient is created, causing the gas to circulate in the direction of flow represented by the arrows 42.

This particular embodiment of the heat pump illustrated in FIGS. 8 to 11 allows for the gas flow order in the first and fourth storage systems 16A, 16D to be “interchanged” during the discharge operation compared with the charging operation, without physically moving the storage systems 16A-16D. The advantage of this operation is that it avoids introducing excessive thermal differences (thermal shocks), which would disrupt the establishment of thermoclines in 16A-16D thermal-energy storage systems and thus be detrimental to the performance of the thermal storage and the application in general.

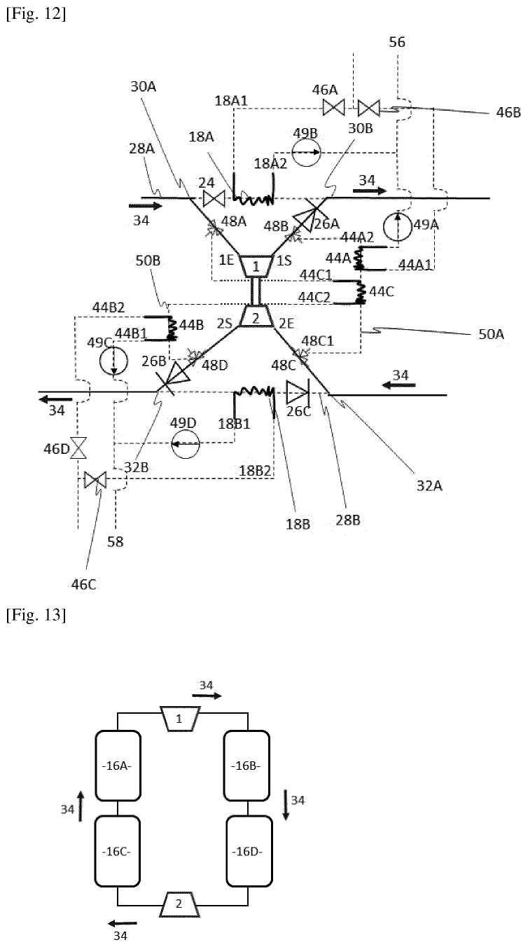

Indicative, non-limiting temperature values are given below by way of example for the particular embodiment of the heat pump illustrated in FIGS. 8 to 11:
the first end 16A1 of the first storage system 16A has, for example, a temperature substantially equal to +60° C., and the second end 16A2 of the first storage system 16A has a temperature substantially equal to +80° C.;
the first end 16B1 of the second storage system 16B has, for example, a temperature substantially equal to +210° C., and the second end 16B2 of the second storage system 16B has a temperature substantially equal to +80° C.;
the first end 16C1 of the third storage system 16C has, for example, a temperature substantially equal to −30° C., and the second end 16C2 of the third storage system 16C has a temperature substantially equal to +80° C.;
the first end 16D1 of the fourth storage system 16D has, for example, a temperature substantially equal to +20° C., and the second end 16D2 of the fourth storage system 16D has a temperature substantially equal to +80° C.;
the fluid circulating in the first thermal-energy release system 18A enters this system 18A with a temperature, for example, substantially equal to +20° C. and leaves this system 18A with a temperature, for example, substantially equal to +200° C.;
the fluid circulating in the second thermal-energy release system 18B enters this system 18B with a temperature, for example, substantially equal to +25° C. and leaves this system 18B with a temperature, for example, substantially equal to −25° C.

[FIG. 12] is a conceptual diagram representing a particular embodiment of a heat pump according to the present invention, in a heat pump charge cycle. Similar to the previous embodiment described with reference to FIGS. 8 to 11, the heat pump according to this particular embodiment comprises a single-stage centrifugal electric turbocharger 1, 2, four thermal-energy storage systems 16A-16D, two thermal-energy release systems 18A, 18B, two three-way valves 20A, 20B, two pumping members 22A, 22B, a two-way valve 24 and three non-return valves 26A-26C (which are all connected in the same way as in the previous embodiment). Apart from the turbocharger 1, 2 and the two thermal-energy release systems 18A, 18B, the other aforementioned components are not shown in [FIG. 12] for reasons of clarity. The heat pump also features three additional thermal-energy release systems 44A-44C, four additional two-way valves 46A-46D and four additional three-way valves 48A-48D, and four additional pumping elements 49A-49D. This particular embodiment shown in FIGS. 12 to 15 is therefore an improvement of the previous embodiment described with reference to FIGS. 8 to 11. In FIGS. 12 to 15, the elements described with the same numerical references as those in FIGS. 8 to 11 are identical to the latter and will therefore not be described in greater detail below.

As illustrated in [FIG. 12], a first end 44A1 of a first additional thermal-energy release system 44A is connected to a first end 18A1 of the first thermal-energy release system 18A via first and second additional two-way valves 46A, 46B. A second end 44A2 of the additional first thermal-energy release system 44A is connected to a second end 18A2 of the first thermal-energy release system 18A. A first end 44B1 of an additional second thermal-energy release system 44B is connected to a first end 18B1 of the second thermal-energy release system 18B. A second end 44B2 of the second additional thermal-energy release system 44B is connected to a second end 18B2 of the second thermal-energy release system 18B via third and fourth additional two-way valves 46C, 46D. A first end 44C1 of a third additional thermal-energy release system 44C is connected to the first connection point 30A on the first gas flow branch 28A; and a second end 44C2 of the third additional thermal-energy release system 44C is connected to the second connection point 32B on the second gas flow branch 28B.

A first additional three-way valve 48A is connected to the inlet 1E of the compressor part 1 of the electric turbocharger, to the first connection point 30A on the first gas flow branch 28A and to the first end 44C1 of the third additional thermal-energy release system 44C. A second additional three-way valve 48B is connected to the outlet 1S of the compressor part 1 of the electric turbocharger, to the second connection point 30B on the first gas flow branch 28A and to one of the channels 48C1 of a third additional three-way valve 48C via a first gas line 50A. The third additional three-way valve 48C is further connected to the inlet 2E of the turbine part 2 of the electric turbocharger and to the first connection point 32A on the second gas flow branch 28B. A fourth additional three-way valve 48D is connected to the outlet 2S of the turbine part 2 of the electric turbocharger, to the second connection point 32B on the second gas flow branch 28B and to the second end 44C2 of the third additional thermal-energy release system 44C via a second gas line 50B.

The first and third additional thermal-energy release systems 44A, 44C are each arranged to exchange thermal energy with the first gas line 50A. The additional second thermal-energy release system 44B is arranged to exchange thermal energy with the second gas line 50B.

A first additional pumping member 49A (typically a pump) connects the second end 44A2 of the first additional release system 44A to the “hot” output 56 of the assembly formed by the first release system 18A and the first additional release system 44A. A second additional pumping member 49B (typically a pump) connects the second end 18A2 of the first release system 18A to the “hot” output 56 of the assembly formed by the first release system 18A and the first additional release system 44A. A third additional pumping member 49C (typically a pump) connects the first end 44B1 of the second additional release system 44B to the “cold” outlet 58 of the assembly formed by the second release system 18B and the second additional release system 44B. A fourth additional pumping member 49D (typically a pump) connects the first end 18B1 of the second release system 18B to the “cold” outlet 58 of the assembly formed by the second release system 18B and the second additional release system 44B.

The operation of the heat pump in this particular embodiment is illustrated in FIGS. 12 and 13, when the pump is in a charge cycle. When in a charge cycle, the heat pump operates in a similar way to the previous embodiment described with reference to FIGS. 8 to 11. In other words, thermal energy in the form of heat is concentrated in the second storage system 16B (after being extracted from the first storage system 16A and then compressed in compressor 1), while thermal energy in the form of cold is concentrated in the third storage system 16C (after being extracted from the fourth storage system 16D and then expanded in turbine 2).

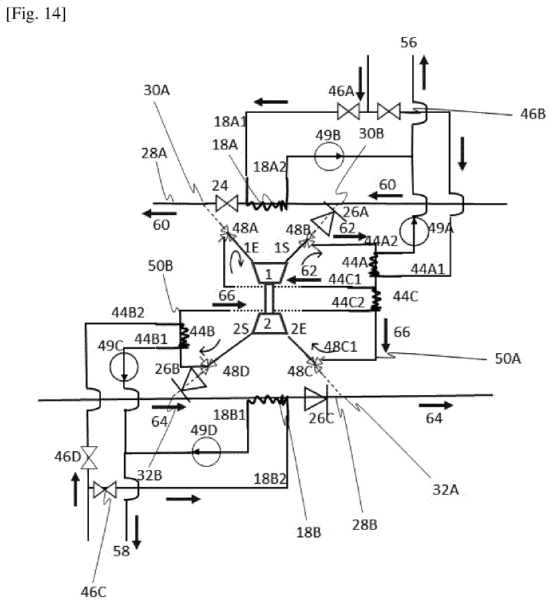

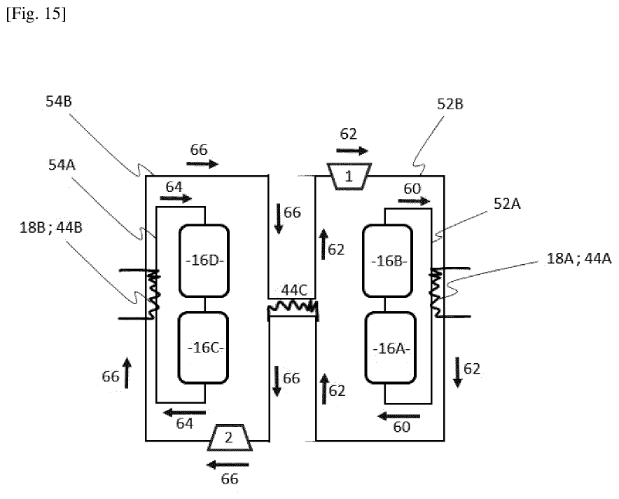

Operation of the heat pump in this particular embodiment is illustrated in FIGS. 14 and 15, when the pump is in a discharge cycle. During the discharge of the heat pump, it is possible to supply heat and cold to customer systems while continuing a parallel charge cycle of the second and third storage systems 16B, 16C. Indeed, as illustrated in [FIG. 15], two heat release loops 52A, 52B are established on the one hand (corresponding to heat release to the first release system 18A and to the first additional release system 44A), and two cold release loops 54A, 54B on the other hand (corresponding to cold release to the second release system 18B and to the second additional release system 44B). For each release circuit (hot on the one hand and cold on the other), each loop 52A, respectively 54A can operate independently of the other loop 52B, respectively 54B, in parallel with the latter or individually.

In the first loop 52A of the heat release circuit (in which the first pumping member 22A and the second additional pumping member 49B are started—this loop 52A being established between the first storage system 16A and the second storage system 16B), the gas flows in the direction of flow represented by the arrows 60. In the second loop 52B of the heat release circuit (in which the first additional pumping member 49A is started—this loop 52B being established at the compressor 1 part of the electric turbocharger, with instantaneous energy produced by the turbocharger 1, 2 and flowing in particular through the first gas line 50A), the gas flows in the direction of flow represented by the arrows 62. In the first loop 54A of the cold release circuit (in which the second pumping member 22B and the fourth additional pumping member 49D are started—this loop 54A being established between the third storage system 16C and the fourth storage system 16D), the gas flows in the direction of flow represented by the arrows 64. In the second loop 54B of the cold release circuit (in which the third additional pumping member 49C is activated—this loop 54B being established at the turbine 2 of the electric turbocharger, with instantaneous energy produced by the turbocharger 1, 2 and flowing in particular in the second gas line 50B), the gas flows in the direction of flow represented by the arrows 66.

In addition to the advantages associated with the previous embodiment (and set out above), this particular embodiment of the heat pump, as illustrated in FIGS. 12 to 15, is capable of producing heat and cold instantaneously, while at the same time discharging heat and cold from thermal-energy storage systems. This is advantageous because it allows for instantaneous power (from the electric turbocharger 1, 2) to be added to the previously stored energy, which is then released in parallel with the instantaneously generated energy, for example to address peak demand with minimal additional equipment costs (three additional thermal-energy release systems 44A-44C). In this particular embodiment illustrated in FIGS. 12 to 15, the discharge of the heat pump can be carried out:
either by supplying only the instantaneous energy produced by the single-stage centrifugal electric turbocharger 1, 2;.
either by simultaneously supplying the stored energy of the thermal-energy storage systems and that of the single-stage centrifugal electric turbocharger (i.e. by discharging the energy produced during the previous charge added to that of the instantaneous power produced by the turbocharger).

This avoids, for example, the need to oversize the system (e.g. by increasing the size of thermal-energy storage systems to store more and/or by increasing the size of the machine, for example to produce more at night).

### EXAMPLES

The attached figures can be reproduced using the parts described below.

### 1. Electrical Turbo-Compressor and Turbine

The turbine and electric compressor are combined in a single turbomachine, which is a single-stage centrifugal electric turbocharger.

For example, one of the following turbochargers can be used:
Garrett “Electric Turbo Compressor (with recovery turbine) for Fuel Cell Electric Vehicles”
Fisher EMTCT-120k Air/EMTCT-90k Air: Electric Micro Turbo compressor with turbine for energy recovery or similar
BorgWarner eTurbo
IHI Fuel Cell Turbocharger
Liebherr-Electrical compressor with turbine (ETC) 25 kW and 55 kW
Mitsubishi® electric turbo-chargers
Holset® electric turbochargers (part of Cummins)

### 2. Storage System: Tanks

Metal tanks, such as standard cylindrical metal vessels (steel or stainless steel) of various sizes, can be thermally insulated and capable of holding compressed air at pressures of up to 10 bar, between 0.5 and 10 m³, or even more.

There are dozens of manufacturers worldwide. The following companies, for example, sell tanks that may be suitable:
Herpasa®; “thermally-insulated tanks”
EMI compressed air®; see for example P 265 GH—EN10028-2; P 275 NH—EN10028-3; P 265 GH-EN10028-2; or the P 275 NH—EN10028-3tank
Kaeser Compressors®;
Colibris Compression®; see for example the vertical galvanized Pauchard tank 2000L BP RTCABJA000

1. An electric heat pump, comprising:
at least two thermal-energy storage systems (4, 5; 16A-16D), and
at least one thermal-energy release system (6; 18A, 18B),
wherein:
at least one of the thermal-energy storage systems (5; 16B) is configured to store thermal-energy in the form of heat at a temperature between +100° C. and +800° C.,
at least one of the thermal-energy storage systems (4; 16C) is configured to store thermal-energy in the form of cold at a temperature between −100° C. and +150° C.; and
said at least one thermal-energy release system (6; 18A, 18B) is configured to release heat and/or cold separately or in parallel over time, or
said at least one thermal-energy release system (6; 18A, 18B) is configured for operation in a parallel release mode which can be alternated with an operation mode of separate release of heat and/or cold over time; the heat pump being configured to comprise a reversed Brayton cycle operating with a gas;
characterized in that the heat pump comprises a single-stage centrifugal electric turbocharger (1, 2).

2. The heat pump according to claim 1, characterized in that the single-stage centrifugal electric turbocharger (1, 2) has a compression ratio of between 1 and 5, the compression ratio being defined as the ratio between the outlet pressure of the compressor section (1) of the turbocharger and the inlet pressure of said compressor section (1).

3. The heat pump according to claim 1 , characterized in that:
at least one of the thermal-energy storage systems (4; 16C) is configured to store thermal-energy at temperatures between −50° C. and +100° C., and/or
in that at least one of the thermal-energy storage systems (5; 16B) is configured to store thermal-energy at temperatures between +150° C. and +500° C., preferably between +200° C. and +400° C.

4. The heat pump according to claim 1, characterized in that said at least two thermal-energy storage systems (4, 5; 16A-16D) are configured to store thermal-energy in the form of heat and in the form of cold.

5. The heat pump according to claim 1, characterized in that the various operating members of said heat pump are isolated in modules, said modules being configured to be connected to one another by, for example, physical connections such as valves, connecting pipes and/or hoses.

6. The heat pump according to claim 1, characterized in that it is configured to be coupled to at least one natural heat source and/or at least one artificial heat source such as a gas boiler, a gas furnace, heat from solar origin or waste heat (11), a dryer and/or heat loss of artificial origin.

7. The heat pump according to claim 1, characterized in that the gas used in the reversed Brayton cycle of the heat pump is air, or a noble gas such as helium or argon, or a mixture of these gases.

8. The heat pump according to claim 1, characterized in that the heat pump comprises four thermal-energy storage systems (16A-16D), two thermal-energy release systems (18A, 18B), two three-way valves (20A, 20B) and two pumping members (22A, 22B); a first end (16A1) of a first thermal-energy storage system (16A) being connected to a first end (16B1) of a second thermal-energy storage system (16B) via a first gas flow branch (28A); a first end (16C1) of a third thermal-energy storage system (16C) being connected to a first end (16D1) of a fourth thermal-energy storage system (16D) via a second gas flow branch (28B); a first thermal-energy release system (18A) being arranged to exchange thermal-energy with the first gas flow branch (28A), a second thermal-energy release system (18B) being arranged to exchange thermal-energy with the second gas flow branch (28B); a first three-way valve (20A) being connected to a second end (16A2) of the first thermal-energy storage system (16A), to a second end (16B2) of the second thermal-energy storage system (16B) and to a second end (16C2) of the third thermal-energy storage system (16C); a second three-way valve (20B) being connected to the second end (16B2) of the second thermal-energy storage system (16B), to the second end (16C2) of the third thermal-energy storage system (16C) and to a second end (16D2) of the fourth thermal-energy storage system (16D); a first pumping member (22A) connecting the second end (16B2) of the second thermal-energy storage system (16B) to the corresponding channel (20A1) of the first three-way valve (20A); a second pumping member (22B) connecting the second end (16C2) of the third thermal-energy storage system (16C) to the corresponding path (20B1) of the second three-way valve (20B); the inlet (1E) of the compressor part (1) of the electric turbocharger being connected to the first end (16A1) of the first thermal-energy storage system (16A) at a first connection point (30A) on the first gas flow branch (28A); the outlet (1S) of the compressor part (1) of the electric turbocharger being connected to the first end (16B1) of the second thermal-energy storage system (16B) at a second connection point (30B) on the first gas flow branch (28A); the inlet (2E) of the turbine part (2) of the electric turbocharger being connected to the first end (16D1) of the fourth thermal-energy storage system (16D) at a first connection point (32A) on the second gas flow branch (28B); the output (2S) of the turbine part (2) of the electric turbocharger being connected to the first end (16C1) of the third thermal-energy storage system (16C) at a second connection point (32B) on the second gas flow branch (28B).

9. The heat pump according to claim 1, characterized in that the heat pump further comprises a two-way valve (24) and three non-return valves (26A, 26B, 26C); the two-way valve (24) being connected to the first gas flow branch (28A) between the first connection point (30A) and the second connection point (30B); a first non-return valve (26A) being connected between the outlet (1S) of the compressor part (1) of the electric turbocharger and the second connection point (30B) of the first gas flow branch (28A); a second non-return valve (26B) being connected between the outlet (2S) of the turbine part (2) of the electric turbocharger and the second connection point (32B) of the second gas flow branch (28B); a third non-return valve (26C) being connected on the second gas flow branch (28B) between the first connection point (32A) and the second connection point (32B).

10. The heat pump according to claim 8, characterized in that the heat pump further comprises three additional thermal-energy release systems, four additional two-way valves (46A-46D) and four additional three-way valves (48A-48D); a first end (44A1) of a first additional thermal-energy release system (44A) being connected to a first end (18A1) of the first thermal-energy release system (18A) via a first and a second two-way valve (46A, 46B); a second end (44A2) of the first additional thermal-energy release system (44A) being connected to a second end (18A2) of the first thermal-energy release system (18A); a first end (44B1) of a second additional thermal-energy release system (44B) being connected to a first end (18B1) of the second thermal-energy release system (18B); a second end (44B2) of the second additional thermal-energy release system (44B) being connected to a second end (18B2) of the second thermal-energy release system (18B) via a third and a fourth two-way valve (46C, 46D); a first end (44C1) of a third additional thermal-energy release system (44C) being connected to the first connection point (30A) on the first gas flow branch (28A); a second end (44C2) of the third additional thermal-energy release system (44C) being connected to the second connection point (32B) on the second gas flow branch (28B); a first additional three-way valve (48A) being connected to the inlet (1E) of the compressor part (1) of the electric turbocharger, to the first connection point (30A) on the first gas flow branch (28A) and to the first end (44C1) of the third additional thermal-energy release system (44C); a second additional three-way valve (48B) being connected to the outlet (1S) of the compressor part (1) of the electric turbocharger, to the second connection point (30B) on the first gas flow branch (28A) and to one of the channels (48C1) of a third additional three-way valve (48C) via a first gas line (50A); the third additional three-way valve (48C) being further connected to the inlet (2E) of the turbine part (2) of the electric turbocharger and to the first connection point (32A) on the second gas flow branch (28B); an additional fourth three-way valve (48D) being connected to the outlet (2S) of the turbine part (2) of the electric turbocharger, to the second connection point (32B) on the second gas flow branch (28B) and to the second end (44C2) of the additional third thermal-energy release system (44C) via a second gas line (50B); the first and third additional thermal-energy release systems (44A, 44C) each being arranged to exchange thermal energy with the first gas line (50A); the second additional thermal-energy release system (44B) being arranged to exchange thermal energy with the second gas line (50B).

11. The method for supplying thermal energy in the form of heat at a temperature between +100° C. and +800° C. and/or cold at a temperature between −100° C. and +150° C., using a heat pump according to claim l, comprising the following steps:
(a) a charge cycle step by mechanical compression of at least one gas with preferably a mechanical expansion of said at least one gas; and
(b) a discharge cycle step without compression and/or expansion in which the thermal energy is discharged via at least one thermal-energy release system, for example via at least one valve, at least one circulator and/or at least one heat exchanger.

12. The method according to claim 11, characterized in that the discharge cycle step (b) is performed in parallel with charge cycle step (a).
